(19) United States
(12) Patent Application Publication
(10) Pub. No.: US 2009/0284377 A1
(43) Pub. Date: Nov. 19, 2009

(54) Flexible RFID Label

(75) Inventors: Mark E. Tuttle, Meridian, ID (US); Roy Edgar Greeff, Boise, ID (US); Freddie W. Smith, Boise, ID (US)

Correspondence Address: GREENBERG TRAURIG, LLP (SV3), IP DOCKETING, 2450 COLORADO AVENUE SUITE 400E, SANTA MONICA, CA, 90404, US

(73) Assignee: KEYSTONE TECHNOLOGY SOLUTIONS, LLC, Boise, ID (US)

(21) Appl. No.: 12/121,357

(22) Filed: May 15, 2008

(51) Int. Cl. G08B 13/14

(52) U.S. Cl. 340/572.7

(57) ABSTRACT

A radio frequency identification (RFID) tag includes a base supporting an integrated circuit and a first antenna orthogonal to a second antenna, the first antenna and the second antenna coupled to the integrated circuit, and a first fold in the base that when creased, defines two lobes lying in two planes, a first lobe including a first portion of the first antenna positioned in an x-axis relative to the second antenna oriented along a y-axis, and a second lobe including a second portion of the first antenna positioned in a z-axis relative to the first portion of the first antenna and second antenna.

### BACKGROUND

The present invention relates to radio frequency identification (RFID), and more particularly to a flexible RFID label.

RFID is a technology that incorporates the use of electromagnetic or electrostatic coupling in the radio frequency (RF) portion of the electromagnetic spectrum to uniquely identify an object, animal, or person. With RFID, the electromagnetic or electrostatic coupling in the RF (radio frequency) portion of the electromagnetic spectrum is used to transmit signals. A typical RFID system includes an antenna and a transceiver, which reads the radio frequency and transfers the information to a processing device (reader) and a transponder, or RF tag, which contains the RF circuitry and information to be transmitted. The antenna enables the integrated circuit to transmit its information to the reader that converts the radio waves reflected back from the RFID tag into digital information that can then be passed on to computers that can analyze the data.

### SUMMARY

The present invention provides methods and apparatus for a flexible RFID label.

In general, in one aspect, the invention features a radio frequency identification (RFID) tag including a base supporting an integrated circuit and a first antenna orthogonal to a second antenna, the first antenna and the second antenna coupled to the integrated circuit, and a first fold in the base that when creased, defines two lobes lying in two planes, a first lobe including a first portion of the first antenna positioned in an x-axis relative to the second antenna oriented along a y-axis, and a second lobe including a second portion of the first antenna positioned in a z-axis relative to the first portion of the first antenna and second antenna.

In another aspect, the invention features a radio frequency identification (RFID) tag including an L-shaped base an integrated circuit and a first antenna orthogonal to a second antenna and a third antenna orthogonal to the first antenna and the second antenna, the first antenna, the second antenna and the third antenna coupled to the integrated circuit, a first fold in the flexible portion that when creased, defines two lobes lying in two planes, a first lobe including a first portion of the first antenna positioned in an x-axis relative to the second antenna oriented along a y-axis, and a second lobe including a second portion of the first antenna positioned in a z-axis relative to the first portion of the first antenna and second antenna, and a second fold in the flexible portion that when creased, defines a third lobe lying in a parallel plane to the first lobe and including a portion of the third antenna.

In another aspect, the invention features a radio frequency identification (RFID) tag including a flexible base including two perpendicular folds and supporting on a first side an integrated circuit and a first portion of an antenna, the first portion of the antenna including a conductor on an end, a second portion of the antenna positioned on a second side of the base and including a conductor on an end, the conductor on the first portion of the antenna and the conductor on the second portion of the antenna making electrical contact at an intersection along one of the folds when creased.

In another aspect, the invention features a radio frequency identification (RFID) device including a L-shaped base including a first and second fold, the first and second folds defining three regions of the base, an integrated circuit positioned on a first region of the base, a first lead and a second lead coupled to the integrated circuit and lying in the first region and a second region of the base, the first lead and the second lead each terminated with a conductor, and a first antenna and a second antenna lying in a third region of the base, the first and second antennas positioned orthogonal to each other and each terminated with a conductor, the conductor on the first lead and the conductor on the first antenna making electrical contact at an intersection along the first fold when the first and second folds can be creased, the conductor on the second lead and the conductor on the second antenna making electrical contact at the intersection along the first fold when the first and second folds can be creased.

Other features and advantages of the invention are apparent from the following description, and from the claims.

### BRIEF DESCRIPTION OF THE DRAWINGS

FIG. 1 is a block diagram of an exemplary RFID tag.

FIG. 2 is a block diagram of an exemplary RFID tag.

FIGS. 3A and 3B are block diagrams of an exemplary RFID tag.

FIGS. 4A and 4B are block diagrams of an exemplary RFID tag.

FIGS. 5A and 5B are block diagrams of an exemplary RFID tag.

FIGS. 6A and 6B are block diagrams of an exemplary RFID tag.

Like reference numbers and designations in the various drawings indicate like elements.

### DETAILED DESCRIPTION

In general, a radio frequency identification (RFID) tag (also referred to as a label or device) is a microchip combined with an antenna in a compact package; the packaging is structured to enable the RFID tag to be attached to an object to be tracked.

The tag's antenna picks up signals from a RFID reader or scanner and then returns the signal, usually with some additional data, such as, for example, a unique serial number or other customized information.

RFID tags can be very small—the size of a large rice grain. Others may be the size of a small paperback book.

In general, a passive tag is a RFID tag that does not contain a battery; the power is supplied by the reader, i.e., the passive tag derives its power from interaction of the antenna and radio waves from the reader.

A tag is an active RFID tag when it is equipped with a battery that can be used as a partial or complete source of power for the tag's circuitry and antenna.

Many hybrid type RFID tags also exist, such as smart tags. These smart tags often include a thin film battery enabling tag flexibility and small form factors.

Antenna polarity in a RFID tag is important because it affects the quality of communication between the RFID interrogator (or scanner) and RFID tag; the RFID interrogator's antenna and the RFID tag's antenna should have the same polarization. If polarization is not realized, a severe loss in signal, along with a drastic decrease in a read range, which results in unsuccessful communication with a RFID tag, can be experienced.

Polarization can be either circular or linear. Linear polarization is relative to the surface of the earth. Linear polarization can also be either horizontal or vertical. Horizontally polarized signals propagate parallel to the earth. Vertically polarized signals propagate perpendicular to the earth.

Antennas with circular polarization can receive signals from both the vertical and horizontal planes by injecting the signal at two points on the antenna radiated slightly out of phase creating a rotating effect on the field. However, there is a slight loss of signal strength, due to the constructive and deconstructive effect of the field being slightly out of phase.

In supply chain applications, portals and tunnels are the commonly used configurations. Energizing and reading RFID tags are exercises in probability, in which the probability has to be maximized to increase the likelihood that a given RFID tag will be in the field of a RFID interrogator's signal long enough that it can be read.

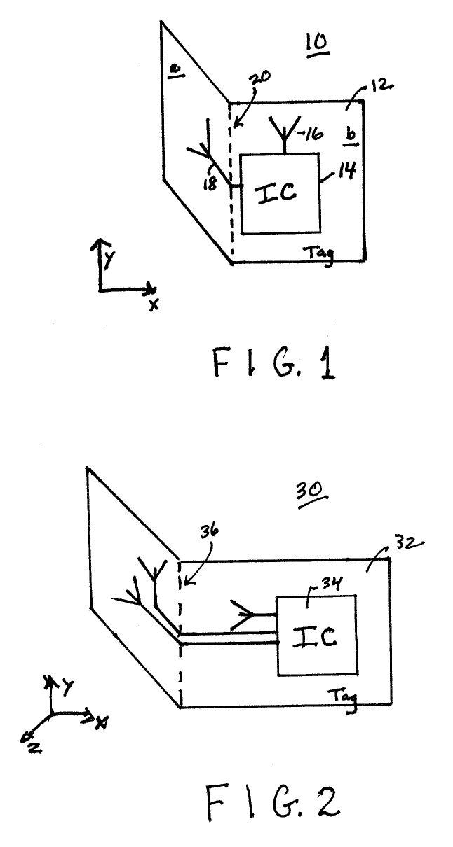

As shown in FIG. 1, an exemplary RFID tag 10 includes a base 12. The base 12 can be non-flexible but often the base is flexible or semi-flexible. The base 12 includes an integrated circuit 14. The integrated circuit 14 is coupled to two orthogonal antennas 16, 18. The base 12 includes a crease 20.

When the base 12 is folded along the crease 20, three dimensions of antenna polarity are achieved by having the orthogonal antennas 16, 18 oriented in two planes or lobes a, b. More specifically, folding or bending the base 12 along the antenna 18 at the crease 20 results in a three dimensional configuration wherein a first portion of the antenna 18 lies in an x-axis relative to antenna 16 on a y-axis, all in a first plane (or lobe) b, and a second portion of the antenna 18 lies in a z-axis relative to the x-axis and y-axis, in a second plane (or lobe) a.

As shown in FIG. 2, an exemplary RFID tag 30 includes a base 32. The base 32 includes an integrated circuit 34 and a crease 36. Three orthogonal antennas 38, 40, 42 are coupled to the integrated circuit 34. Bending the base 32 at the crease 36 again results in three dimensions of antenna polarity.

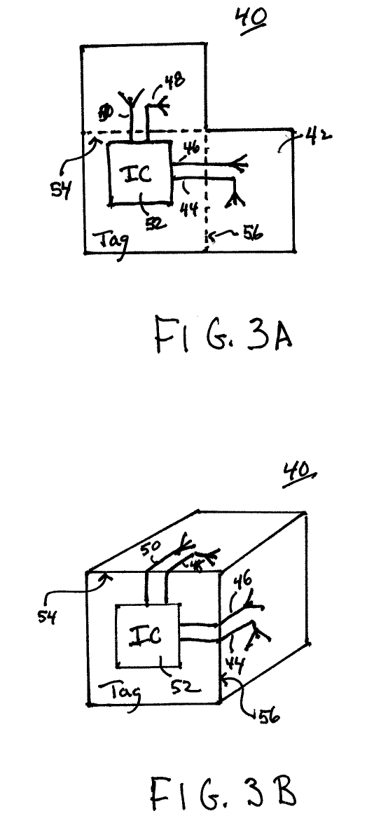

As shown in FIG. 3A, an exemplary RFID tag 40 includes an L-shaped base 42. The base 42 includes four orthogonal antennas 44, 46, 48, 50 coupled to an integrated circuit 52. The base 42 also includes two creases or folds 54, 56.

As sown in FIG. 3B, the RFID tag 40 with two bends 54, 56 in the base 42 having four orthogonal antennas 44, 46, 48, 50 is advantageous as a corner cap on a shipping box, for example. The bends 54, 56 can be perforations, folds, creases, and so forth.

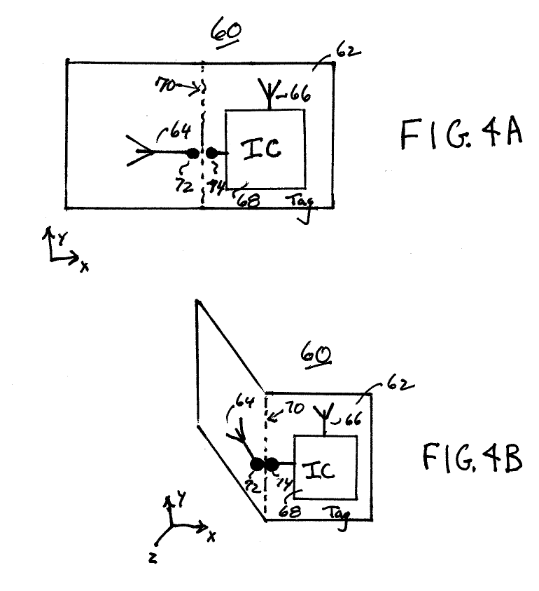

As shown in FIG. 4A, an exemplary RFID tag 60 includes a base 62. The base 62 includes two orthogonal antennas 64, 66 coupled to an integrated circuit 68. The base also includes a fold 70. Antenna 64 includes conductors 72, 74.

As shown in FIG. 4A, when the base 62 is folded along the fold 70, conductors 72, 74 make electrical contact, completing antenna 64. The conductors 72, 74 can also be used to make a single antenna that is built in two planes. The antenna can be a loop with multiple contact points along edges that are folded together. The conductors 72, 74 can be connected by touching contact or by soldering or by using an adhesive conductor.

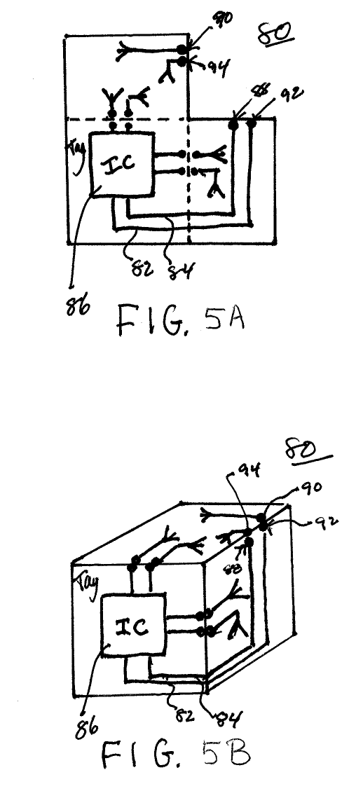

As shown in FIG. 5A, an exemplary RFID tag 80 includes longer antennas 82, 84 coupled to an integrated circuit 86, along with conductors 88, 90, 92, 94. As shown in FIG. 5B, when folded, the conductors 88, 90, 92, 94 make electrical contact and antennas 82, 84 lie in three different planes.

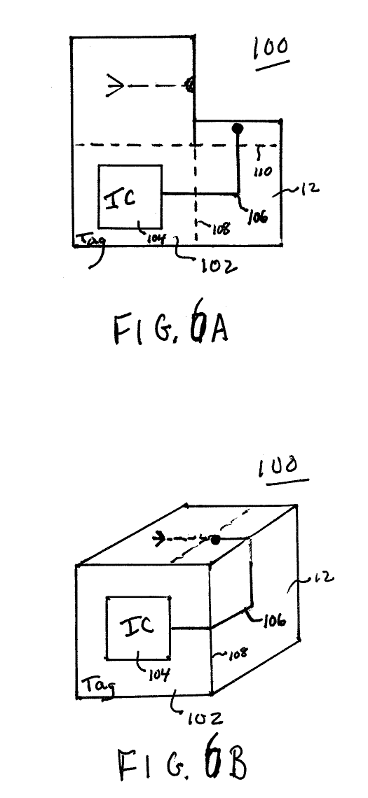

As shown in FIG. 6A, an exemplary RFID tag 100 includes a base 102. The base 102 includes an integrated circuit 104 coupled to a first portion of an antenna 106. The integrated circuit 104 and first portion of antenna 106 lie on one side of the base 102, a second portion of antenna 106 lies on a back side of the base 102. The ends of each antenna portion include conductors.

The base 102 also includes two folds 108, 110. As shown in FIG. 6B, when base 102 is folded at folds 108, 110, the first portion of antenna 106, on the side of the tag 100 with the integrated circuit 104, makes electrical contact with the second portion of antenna 106 located on the back side of the base 102; this connection is made by overlapping at the fold causing the conductors to make electrical contact. No via through the base is needed.

The invention can be implemented to realize one or more of the following advantages. A flexible RFID tag can include slits or perforations to enable one flap to cross over another, and in some cases, make electrical contact to the underlying flap. A side fold (or corner) tag can include multiple antennas intended to generate orthogonal radiation patterns.

It is to be understood that the foregoing description is intended to illustrate and not to limit the scope of the invention, which is defined by the scope of the appended claims. Other embodiments are within the scope of the following claims.

What is claimed is:

1. A radio frequency identification (RFID) tag comprising:
a base supporting an integrated circuit and a first antenna orthogonal to a second antenna, the first antenna and the second antenna coupled to the integrated circuit; and
a first fold in the base that when creased, defines two lobes lying in two planes, a first lobe including a first portion of the first antenna positioned in an x-axis relative to the second antenna oriented along a y-axis, and a second lobe including a second portion of the first antenna positioned in a z-axis relative to the first portion of the first antenna and second antenna.

2. The RFID tag of claim 1 wherein the first lobe includes a first conductor on an end of the first portion of the first antenna and the second lobe includes a second conductor on an end of the second portion of the first antenna, the first conductor and the second conductor making electrical contact at an intersection along the first fold when creased.

3. The RFID tag of claim 1 wherein the first fold comprises perforations.

4. The RFID tag of claim 1 wherein the base is L-shaped.

5. The RFID tag of claim 4 wherein the flexible portion further comprises:
a third antenna coupled to the integrated circuit and orthogonal to the first antenna and the second antenna; and
a second fold that when creased, defines a third lobe lying in a parallel plane and including a portion of the third antenna.

6. The RFID tag of claim 5 wherein the second fold comprises perforations.

7. A radio frequency identification (RFID) tag comprising:
an L-shaped base an integrated circuit and a first antenna orthogonal to a second antenna and a third antenna orthogonal to the first antenna and the second antenna, the first antenna, the second antenna and the third antenna coupled to the integrated circuit;
a first fold in the flexible portion that when creased, defines two lobes lying in two planes, a first lobe including a first portion of the first antenna positioned in an x-axis relative to the second antenna oriented along a y-axis, and a second lobe including a second portion of the first antenna positioned in a z-axis relative to the first portion of the first antenna and second antenna; and
a second fold in the flexible portion that when creased, defines a third lobe lying in a parallel plane to the first lobe and including a portion of the third antenna.

8. The RFID tag of claim 7 wherein the first fold and the second fold comprise perforations.

9. The RFID tag of claim 7 wherein the first fold and the second fold comprise creases.

10. A radio frequency identification (RFID) tag comprising:
a flexible base comprising two perpendicular folds and supporting on a first side an integrated circuit and a first portion of an antenna, the first portion of the antenna including a conductor on an end;
a second portion of the antenna positioned on a second side of the base and including a conductor on an end;
the conductor on the first portion of the antenna and the conductor on the second portion of the antenna making electrical contact at an intersection along one of the folds when creased.

11. The RFID tag of claim 10 wherein the first fold and the second fold comprise perforations.

12. The RFID tag of claim 10 wherein the first fold and the second fold comprise creases.

14. A radio frequency identification (RFID) device comprising:
a L-shaped base including a first and second fold, the first and second folds defining three regions of the base;
an integrated circuit positioned on a first region of the base;
a first lead and a second lead coupled to the integrated circuit and lying in the first region and a second region of the base, the first lead and the second lead each terminated with a conductor; and
a first antenna and a second antenna lying in a third region of the base, the first and second antennas positioned orthogonal to each other and each terminated with a conductor, the conductor on the first lead and the conductor on the first antenna making electrical contact at an intersection along the first fold when the first and second folds are creased, the conductor on the second lead and the conductor on the second antenna making electrical contact at the intersection along the first fold when the first and second folds are creased.

15. The RFID tag of claim 14 wherein the first fold and the second fold comprise perforations.

16. The RFID tag of claim 14 wherein the first fold and the second fold comprise creases.
